(19) United States
(12) Patent Application Publication
(10) Pub. No.: US 2026/0252313 A1
(43) Pub. Date: Aug. 27, 2026

(54) SIGNED INTEGER MODULAR MULTIPLICATION APPARATUS, SIGNED INTEGER MODULAR MULTIPLICATION METHOD, AND PROGRAM

(71) Applicant: NEC Corporation, Minato-ku, Tokyo (JP)

(72) Inventor: Daichi AOKI, Tokyo (JP)

(73) Assignee: NEC Corporation, Minato-ku, Tokyo (JP)

(21) Appl. No.: 18/854,627

(22) PCT Filed: Apr. 13, 2022
(86) PCT No.: PCT/JP2022/017737

§ 371 Date: Oct. 7, 2024

(51) Int. Cl. G06F 7/72; G06F 7/48

(52) U.S. Cl. CPC G06F 7/722; G06F 7/4824

(57) ABSTRACT

A signed integer modular multiplication apparatus includes input part receiving first signed integer, second signed integer, modular arithmetic divisor P, positive integer n, and constant R; multiplication part; and upper bit acquisition part. multiplication part calculates first product of 2n bits in length from second signed integer and constant R, multiplication part calculates second product of 2n bits in length from first product and first signed integer, upper bit acquisition part performs integer approximation on result of signed n-bit right shift on second product to acquire first upper bits, multiplication part calculates third product of 2n bits in length from first upper bits and modular arithmetic divisor P, and upper bit acquisition part performs integer approximation on result of signed n-bit right shift on third product to acquire second upper bits. Constant R is a reciprocal of modular arithmetic divisor P by calculation of signed integer modulo2²ⁿ.

### FIELD

The present invention relates to a signed integer modular multiplication apparatus, a signed integer modular multiplication method, and a program.

### BACKGROUND

Patent Literature (PTL) 1 relates to a calculation method for a modular arithmetic system of efficiently calculating a modular multiplication by using a bipartite modular multiplication with a simple hardware configuration.

PTL 2 relates to a power modular arithmetic method for calculating an inverse element at high speed required in the Montgomery multiplication algorithm without using a dedicated inverse element calculator.

PTL 3 relates to a cryptographic processing apparatus improving processing speed when a modular division is performed using the Montgomery method.

### CITATION LIST

### Patent Literature

PTL 1: JP2007-219261A
PTL 2: JP2004-226516A
PTL 3: JP2003-150050A

### SUMMARY

### Technical Problem

The following analysis is given by the inventor.

There are various application examples of efficient calculation methods of a remainder of a product, one example of which is a Number Theoretic Transform (NTT) is a technology similar to the Fast Fourier Transform (FFT), and particularly refers to FFT on a factor ring. It is necessary to calculate a large number of remainders of products, therefor an efficient calculation method of a remainder of a product is important.

Further, the number theoretic transform is applied to an algorithm for a fast multiplication of polynomials. A polynomial ring is often used in public-key cryptography, a type of lattice cryptography that relies on the computational difficulty of a mathematical problem called a lattice problem as a basis for security, and fast polynomial multiplication algorithms are important in practice, therefor the number theoretic transform is often used.

Note that, the number theoretic transform is not necessarily applicable to all lattice cryptography using a polynomial ring due to limitations of parameters, etc. For example, although lattice cryptography such as Saber and NTRU were selected as final candidates in the standardization competition for post-quantum cryptography by the National Institute of Standards and Technology, since they use a polynomial ring that is unsuitable for the number theoretic transform, the number theoretic transform is not adopted in the polynomial multiplication algorithm.

However, in recent years, a method for performing a number theoretic transform even in a polynomial ring that is not suitable for a number theoretic transform has been proposed, and it has become possible to use a number theoretic transform in a polynomial multiplication algorithm in the above-mentioned Saber and NTRU. It would be of great significance when it were possible to speed up a polynomial multiplication in Saber and NTRU by improving an efficiency of a calculation of a remainder of a product.

In order to introduce a number theoretic transform into a polynomial ring that is not suitable for a number theoretic transform, it is necessary to use signed integer representations.

Regarding the calculation of a remainder of a product (modular multiplication), there is, for example, a calculation method of Montgomery multiplication as introduced in PTL 1. In the calculation method of Montgomery multiplication, a division by a modular arithmetic divisor required for a calculation of a remainder of a product is performed by multiplication, a modular arithmetic of a power of 2, and a division by a power of 2, thereby calculating the remainder of the product without performing a division by the modular arithmetic divisor, and it is possible to accelerate the calculation of the remainder of the product.

Additionally, methods have been proposed that are derived from a calculation method by the Montgomery multiplication and that make it possible to further accelerate a calculation of a remainder of a product. However, all methods, including Montgomery multiplication, can only handle unsigned data. Therefore, when calculating a remainder of a product using signed data, previously proposed methods for accelerating a calculation of a remainder of a product have required converting negative data to unsigned data, calculating a remainder of a product of the unsigned data, then performing a conditional branch and converting it into a modular arithmetic result of signed data.

In addition, the method of converting negative data into data represented by an unsigned integer, calculating a remainder of a product (modular multiplication) of the unsigned data, thereafter performing a conditional branch, and converting it into a result of the modular arithmetic of data represented by a signed integer not only increases the amount of processing and reduces efficiency, but also makes fixed-time implementation impossible due to the conditional branch, resulting in loosing resistance against side-channel attacks called as timing attacks, therefore the method cannot be used for cryptographic implementation.

It is an object of the present invention to provide a signed integer modular multiplication apparatus, a signed integer modular multiplication method, and a program that contribute to making it possible to calculate a remainder of a product on data represented by signed integers without converting negative data into data represented by unsigned integers.

### Solution to Problem

According to a first aspect of the present invention, there is provided a signed integer modular multiplication apparatus, comprising:
an input part receiving a first signed integer, a second signed integer,
a modular arithmetic divisor P, a positive integer n, and a constant R;
a multiplication part; and
an upper bit acquisition part, wherein
the multiplication part calculates a first product of 2n bits in length from the second signed integer and the constant R,
the multiplication part calculates a second product of 2n bits in length from the first product and the first signed integer,
the upper bit acquisition part performs integer approximation on a result of a signed n-bit right shift on the second product to acquire first upper bits,
the multiplication part calculates a third product of 2n bits in length from the first upper bits and the modular arithmetic divisor P, and
the upper bit acquisition part performs integer approximation on the result of a signed n-bit right shift on the third product to acquire second upper bits, and wherein
the constant R is a reciprocal of the modular arithmetic divisor P by a calculation of a signed integer modulo2²ⁿ.

According to a second aspect of the present invention, there is provided a signed integer modular multiplication apparatus, comprising:
an input part receiving a first signed integer, a first product of 2n bits in length calculated in advance from a second signed integer and a constant R, a modular arithmetic divisor P, a positive integer n;
a multiplication part; and
an upper bit acquisition part, wherein
the multiplication part calculates a second product of 2n bits in length from the first product and the first signed integer,
the upper bit acquisition part performs integer approximation on a result of a signed n-bit right shift on the second product to acquire first upper bits,
the multiplication part calculates a third product of 2n bits in length from the first upper bits and the modular arithmetic divisor P, and
the upper bit acquisition part performs integer approximation on the result of a signed n-bit right shift on the third product to acquire second upper bits, and wherein
the constant R is a reciprocal of the modular arithmetic divisor P by a calculation of a signed integer modulo 2²ⁿ.

According to a third aspect of the present invention, there is provided a signed integer modular multiplication method comprising steps of:
receiving a first signed integer, a second signed integer, a modular arithmetic divisor P, a positive integer n, and a constant R with an input part;
calculating a first product of 2n bits in length from the second signed integer and the constant R with a multiplication part;
calculating a second product of 2n bits in length from the first product and the first signed integer with the multiplication part;
performing integer approximation on a result of a signed n-bit right shift on the second product to acquire first upper bits with an upper bit acquisition part;
calculating a third product of 2n bits in length from the first upper bits and the modular arithmetic divisor P with the multiplication part; and
performing integer approximation on the result of a signed n-bit right shift on the third product to acquire second upper bits with the upper bit acquisition part, and wherein
the constant R is a reciprocal of the modular arithmetic divisor P by a modular calculation of a signed integer modulo 2²ⁿ.
   The present method is tied to a particular machine, namely, a computer for performing a calculation of a remainder of a product on data represented by signed integers.

According to a fourth aspect of the present invention, there is provided a signed integer modular multiplication method, comprising steps of:
receiving a first signed integer, a first product of 2n bits in length calculated in advance from a second signed integer and a constant R, a modular arithmetic divisor P, and a positive integer n with an input part;
calculating a second product of 2n bits in length from the first product and the first signed integer with a multiplication part;
performing integer approximation on a result of a signed n-bit right shift on the second product to acquire first upper bits with an upper bit acquisition part;
calculating a third product of 2n bits in length from the first upper bits and the modular arithmetic divisor P with the multiplication part; and
performing integer approximation on the result of a signed n-bit right shift on the third product to acquire second upper bits with the upper bit acquisition part, and wherein
the constant R is a reciprocal of the modular arithmetic divisor P by a modular calculation of a signed integer modulo 2²ⁿ.
   The present method is tied to a particular machine, namely, a computer for performing a calculation of a remainder of a product on data represented by signed integers.

According to a fifth aspect of the present invention, there is provided a program, causing a computer to execute processings of:
receiving a first signed integer, a second signed integer, a modular arithmetic divisor P, a positive integer n, and a constant R;
calculating a first product of 2n bits in length from the second signed integer and the constant R;
calculating a second product of 2n bits in length from the first product and the first signed integer;
performing integer approximation on a result of a signed n-bit right shift of the second product to acquire first upper bits;
calculating a third product of 2n bits in length from the first upper bits and the modular arithmetic divisor P; and
performing integer approximation on the result of a signed n-bit right shift of the third product to acquire second upper bits, wherein
the constant R is a reciprocal of the modular arithmetic divisor P by a modular calculation of a signed integer modulo 2²ⁿ.

According to a sixth aspect of the present invention, there is provided a program, causing a computer to execute processings of:
receiving a first signed integer, a first product of 2n bits in length calculated in advance from a second signed integer and a constant R, a modular arithmetic divisor P, and a positive integer n;
calculating a second product of 2n bits in length from the first product and the first signed integer;
performing integer approximation on a result of a signed n-bit right shift of the second product to acquire first upper bits;
calculating a third product of 2n bits in length from the first upper bits and the modular arithmetic divisor P; and
performing integer approximation on the result of a signed n-bit right shift of the third product to acquire second upper bits, and wherein
the constant R is a reciprocal of the modular arithmetic divisor P by a modular calculation of a signed integer modulo 2²ⁿ.

It is to be noted that this program may be recorded on a computer-readable storage medium. The storage medium can be non-transitory one, such as a semiconductor memory, a hard disk, a magnetic recording media, an optical recording media and so on. The present invention can be implemented as a computer program product.

### Advantageous Effects of Invention

According to the present invention, there are provided a signed integer modular multiplication apparatus, a signed integer modular multiplication method, and a program that contribute to making it possible to calculate a remainder of a product on data represented by signed integers without converting negative data into data represented by unsigned integers.

### BRIEF DESCRIPTION OF DRAWINGS

FIG. 1 is a diagram showing an example of a schematic configuration of a signed integer modular multiplication apparatus according to an example embodiment of the present invention.

FIG. 2 is a flowchart illustrating an example of a process performed by a signed integer modular multiplication apparatus according to the example embodiment of the present invention.

FIG. 3 is a diagram illustrating an example of a schematic configuration of a signed integer modular multiplication apparatus according to another example embodiment of the present invention.

FIG. 4 is a flowchart illustrating an example of a process performed by a signed integer modular multiplication apparatus according to another example embodiment of the present invention.

FIG. 5 is a diagram illustrating an example of a configuration of a signed integer modular multiplication apparatus according to a first example embodiment of the present invention.

FIG. 6 is a diagram illustrating an example of a configuration of an upper bit acquisition part of a signed integer modular multiplication apparatus according to the first example embodiment of the present invention.

FIG. 7 is a diagram illustrating an example of a configuration of a signed integer modular multiplication apparatus according to a second example embodiment of the present invention.

FIG. 8 is a diagram illustrating an example of a configuration of a signed integer modular multiplication apparatus according to a third example embodiment of the present invention.

FIG. 9 is a diagram illustrating an example of a configuration of a signed integer modular multiplication apparatus according to a fourth example embodiment of the present invention.

FIG. 10 is a diagram showing an example of a configuration of a computer that makes up a signed integer modular multiplication apparatus of the present invention.

### EXAMPLE EMBODIMENTS

### One Example Embodiment of the Present Invention

First, an outline of one example embodiment of the present invention will be described with reference to the drawings. Note, in the following outline, reference signs of the drawings are denoted to each element as an example for the sake of convenience to facilitate understanding, and are is not intended to limit the present invention to the illustrated modes. Furthermore, the connection lines between blocks in the drawings and the like referred to in the following description include both one-way and two-way directions. A one-way arrow schematically illustrates a principal signal (data) flow and does not exclude bidirectionality.

### [Details of Calculation of Remainder of Product of Signed Integers]

In one example embodiment of the present invention, inputs are a first signed integer A, a second signed integer B, a modular arithmetic divisor P, a positive integer n, and a constant R. Here, the integer n is a half word length of a computer that performs the calculation, or a product to be calculated. Here, the constant R is an integer that satisfies

$$R = {P}^{- 1} {mod}^{\pm } {2}^{2 n} \qquad expression ( 1 )$$

and “mod^{±}2²ⁿ indicates a modular calculation of a signed integer modulo 2²ⁿ, and a result of a modular calculation is any one value of

$$\{ - {2}^{2 n - 1} , - {2}^{2 n - 1} + 1 , … , - 1 , 0 , 1 , … , {2}^{2 n - 1} - 1 \} .$$

Further, a first signed integer A and a second signed integer B are signed integers satisfying

$$A , B ∈ [ - \frac{P - 1}{2} , … , \frac{P - 1}{2} ] .$$

In one example embodiment of the present invention, a remainder of a product of signed integers

$$AB ( - {2}^{- 2 n} ) {mod}^{\pm } P \qquad expression ( 2 )$$

with a modular arithmetic divisor P is calculated by using

$$〚 \frac{〚 \frac{ABR {mod}^{\pm } {2}^{2 n}}{{2}^{n}} 〛 P}{{2}^{n}} 〛 \qquad expression ( 3 )$$

from the above inputs.

Note, that

$$〚 \cdot 〛$$

is an integer approximation function, and it is selected so that it satisfies

$$〚 z + α 〛 = z$$

for any integer z and real number

$$α ( - \frac{1}{2} \leq α < \frac{1}{2} ) .$$

As such an integer approximation function

$$〚 \cdot 〛 ,$$

there is a function
that rounds a first decimal place of a real number x, for example.

### [Schematic Configuration and Operation of Signed Integer Modular Multiplication Apparatus]

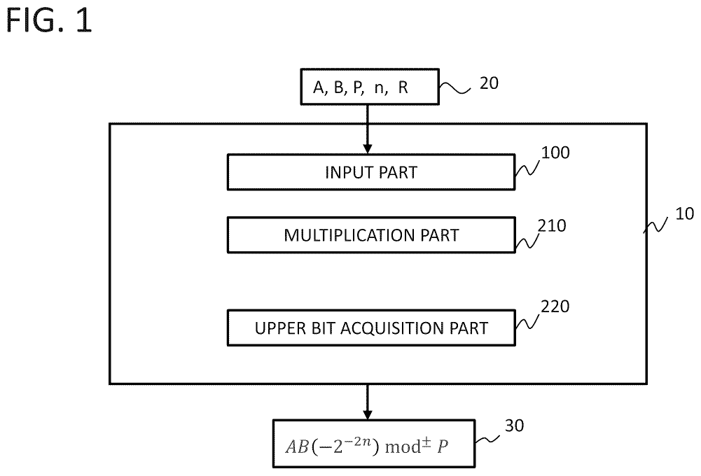

First, a schematic configuration of a signed integer modular multiplication apparatus (calculation apparatus of a remainder of a product of signed integers) according to one example embodiment of the present invention will be described. FIG. 1 is a diagram showing an example of a schematic configuration of a signed integer modular multiplication apparatus according to one example embodiment of the present invention. Referring to FIG. 1, the signed integer modular multiplication apparatus 10 includes an input part 100, a multiplication part 210, and an upper bit acquisition part 220.

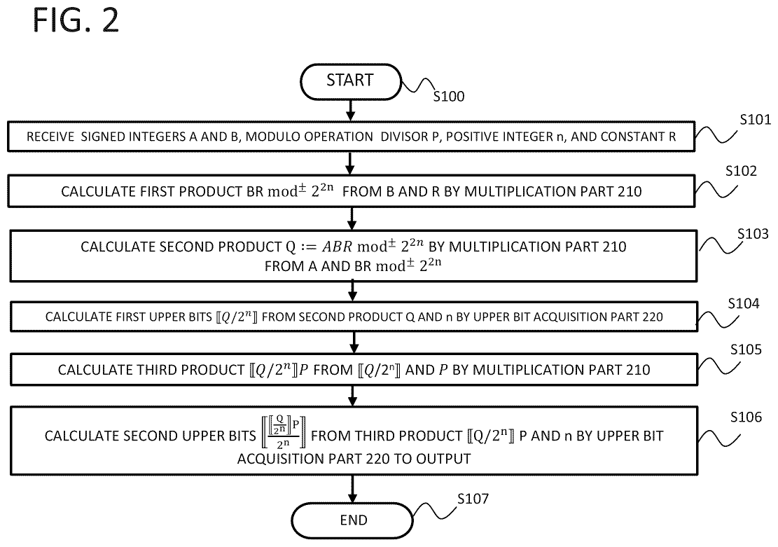

Next, a description will be made with reference to FIG. 2 regarding the operation of the signed integer modular multiplication apparatus 10 according to one example embodiment of the present invention shown in FIG. 1. FIG. 2 is a flowchart showing an example of processing by the signed integer modular multiplication apparatus 10 according to one example embodiment of the present invention. The processing starts at step S100.

In step S101, the input part 100 receives an input 20 including a first signed integer A, a second signed integer B, a modular arithmetic divisor P, a positive integer n, and a constant R. The input part 100 may be implemented, for example, by a character input apparatus such as a keyboard for inputting the input 20. The constant R is an integer satisfying

$$R = {P}^{- 1} {mod}^{\pm } {2}^{2 n}$$

for the modular arithmetic divisor P and the positive integer n, and mod^{±}2²ⁿ denotes a modular calculation of a signed integer modulo 2²ⁿ.

In step S102, the multiplication part 210 calculates a first product of 2n bits in length

$$BR {mod}^{\pm } {2}^{2 n}$$

from the second signed integer B and the constant R.

Next, in step S103, the multiplication part 210 calculates a second product of 2n bits in length

$$Q = ABR {mod}^{\pm } {2}^{2 n}$$

from a first product and the first signed integer A.

Next, in step S104, the upper bit acquisition part 220 performs integer approximation on the result of a signed n-bit right shift (Q>>n (=Q/2ⁿ)) to the second product Q to acquire first upper bits

$$〚 Q / {2}^{n} 〛 .$$

Next, in step S105, the multiplication part 210 calculates the third product of 2n bits in length

$$〚 Q / {2}^{n} 〛 P$$

from the first upper bits and the modular arithmetic divisor P.

Finally, in step S106, the upper bit acquisition part 220 performs integer approximation on the result of the signed n-bit right shift of the third product to acquire the second upper bits

$$〚 \frac{〚 \frac{Q}{{2}^{n}} 〛 P}{{2}^{n}} 〛 ,$$

and outputs it as output 30.
The process ends in step S107.

### Example of Calculation of Remainder of Product of Signed Integers

Next, an example of a modular calculation by the signed integer modular multiplication apparatus 10 of one example embodiment of the present invention will be described. Note that the signed integer modular multiplication apparatus 10 of one example embodiment of the present invention receives signed integers in two's complement representation and performs each calculation using signed integers in two's complement representation, however, in the following description, each numerical value will be expressed in decimal. The signed integer modular multiplication apparatus 10 of one example embodiment of the present invention receives a first signed integer “A=−12”, a second signed integer “B=19”, a modular arithmetic divisor “P=101”, a positive integer “n=8”, and a constant R, where

$$R = {P}^{- 1} {mod}^{\pm } {2}^{2 n} = - 20115 \qquad expression ( 4 )$$

as inputs.

Using the above-described inputs, when directly performing a calculation of a remainder by a product of signed integers modulo P using expression (2), the result of the calculation is

$$AB ( - {2}^{- 2 n} ) {mod}^{\pm } P = - 2. \qquad expression ( 5 )$$

In contrast, the calculation process when the above described expression (3) is calculated by the signed integer modular multiplication apparatus 10 according to one example embodiment of the present invention will be described below.

When the multiplication part 210 calculates the first product of 2n (16) bits in length of the second signed integer B×constant R=19×(−20115),

BR mod^{±}2²ⁿ=11031 of the expression (3) can be calculated, and the value 11031 is acquired as the result.

Next, the multiplication part 210 calculates the second product of 2n bits (16 bits) in length, as the first signed integer A×the first product “=−12×11031”, the result of

Q=ABR mod^{±}2²ⁿ=−1300 of the expression (3) can be calculated, and the value −1300 is acquired as the result.

Next, when the upper bit acquisition part 220 performs a signed n-bit right shift on the second product, and performs integer approximation on the result to acquire the first upper bits,

$$〚 Q / {2}^{n} 〛 = - 5$$

in the expression (3) can be calculated, and −5 is acquired as the result.

Next, the multiplication part 210 calculates the third product of 2n bits (16 bits) in length, as the first upper bits×the modular arithmetic divisor P,

$$〚 Q / {2}^{n} 〛 P = - 505$$

in the expression (3) can be calculated, and −505 is acquired as the result.

Finally, when the upper bit acquisition part 220 performs a signed n-bit right shift on the third product and performs integer approximation on the result to acquire the second upper bits,

$$〚 \frac{〚 \frac{Q}{{2}^{n}} 〛 P}{{2}^{n}} 〛 = - 2. \qquad expression ( 6 )$$

in the expression (3) is calculated, and the value −2 is acquired as the result to be output as the output 30 of the remainder of the product.

By comparing the above described expressions (5) and (6), the signed integer modular multiplication apparatus 10 of one example embodiment of the present invention can calculate the remainder of the product of the signed integers

$$AB ( - {2}^{- 2 n} ) {mod}^{\pm } P .$$

According to one example embodiment of the present invention, there is provided a signed integer modular multiplication apparatus, a signed integer modular multiplication method, and a program that contribute to making it possible to calculate a remainder of a product on data represented by signed integers without converting negative data to data represented by unsigned integers.

### Another Example Embodiment of the Present Invention

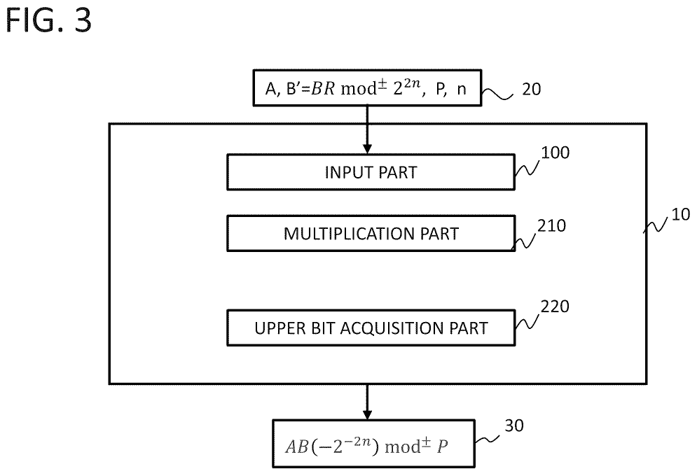

Next, an outline of another example embodiment of the present invention will be described with reference to the drawings. FIG. 3 is a diagram showing an example of a schematic configuration of a signed integer modular multiplication apparatus 10 according to another example embodiment of the present invention. In FIG. 3, it is assumed that the components with the same reference signs as those in FIG. 1 are the same, and their description will be omitted.

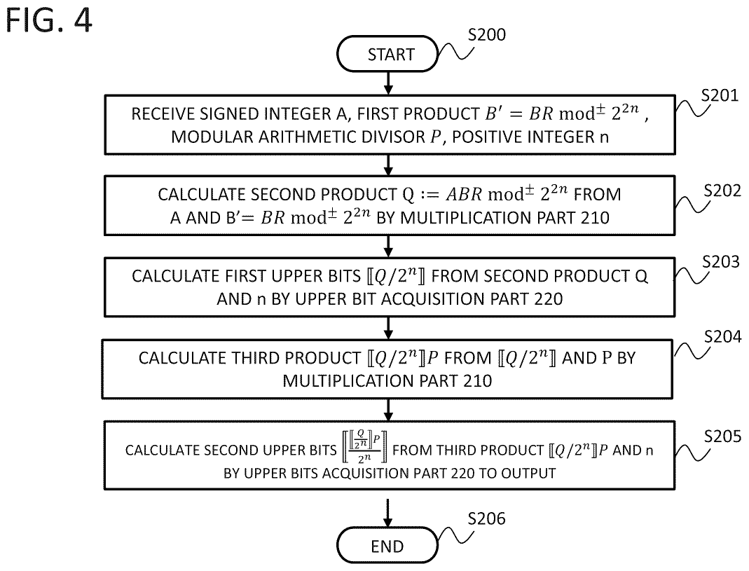

Next, the operation of the signed integer modular multiplication apparatus 10 according to another example embodiment of the present invention will be described with reference to FIG. 4. FIG. 4 is a flowchart showing an example of processing by the signed integer modular multiplication apparatus 10 according to another example embodiment of the present invention. The processing starts at step S200.

Depending on an application of a modular multiplication, the pre-calculation of a first product

$${B}^{′} = BR {mod}^{\pm } {2}^{2 n}$$

may be performed. Another example embodiment of the present invention is in case where the first product is calculated in advance.

In step S201, the input part 100 receives a first signed integer A, a first product

$${B}^{′} = BR {mod}^{\pm } {2}^{2 n} ,$$

the modular arithmetic divisor P, and an integer n as input 20, without receiving a second signed integer B and a constant R.

Next, in step S202, the multiplication part 210 calculates the second product of 2n bits in length

$$Q = ABR {mod}^{\pm } {2}^{2 n}$$

from the first product and the first signed integer.

Next, in step S203, an upper bit acquisition part 220 performs integer approximation on the result of a signed n-bit right shift of the second product to acquire the first upper bits

$$〚 Q / {2}^{n} 〛 .$$

Next, in step S204, the multiplication part 210 calculates the third product of 2n bits in length

$$〚 Q / {2}^{n} 〛 P$$

from the first upper bits and the modular arithmetic divisor P.

Next, in step S205, the upper bit acquisition part 220 performs integer approximation on the result of the signed n-bit right shift of the third product to acquire second upper bits

$$〚 \frac{〚 \frac{Q}{{2}^{n}} 〛 P}{{2}^{n}} 〛$$

to output it as the output 30. The process ends in step S206.

The signed integer modular multiplication apparatus 10 according to another example embodiment of the present invention shown in FIG. 3 can acquire, from the above input, second upper bits same as the second upper bits acquired by the signed integer modular multiplication apparatus 10 according to one example embodiment of the present invention shown in FIG. 1, and output it as the output 30.

According to another example embodiment of the present invention, there is provided a signed integer modular multiplication apparatus, a signed integer modular multiplication method s, and a program that contribute to making it possible to calculate a remainder of a product on data represented by signed integers without converting negative data into data represented by an unsigned integer.

Further, according to another example embodiment of the present invention, in an application example in which the first product can be pre-calculated, step S102 of calculating the first product in one example embodiment of the present invention described with reference to FIGS. 1 and 2 can be omitted, thereby enabling the calculation of the remainder of the product to be performed at a high speed.

### First Example Embodiment

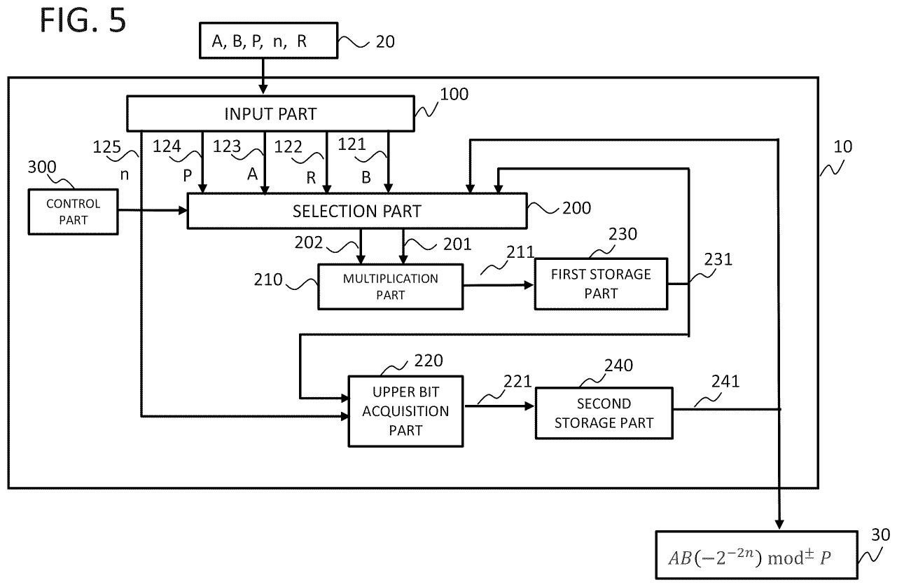

Next, a description will be made regarding a signed integer modular multiplication apparatus (calculation apparatus of a remainder of a product of signed integers) according to a first example embodiment of the present invention with reference to the drawings. FIG. 5 is a diagram showing an example of the configuration of a signed integer modular multiplication apparatus 10 according to a first example embodiment of the present invention. In FIG. 5, it is assumed that the components with the same reference signs as those in FIG. 1 are the same, and their description will be omitted.

Referring to FIG. 5, the signed integer modular multiplication apparatus 10 of the first example embodiment of the present invention includes an input part 100, a selection part 200, a multiplication part 210, an upper bit acquisition part 220, a first storage part 230, a second storage part 240, and a control part 300. Note that, it is assumed that the signed integer modular multiplication apparatus 10 of each of the following embodiments of the present invention receives signed integers in two's complement representation and performs each calculation using the signed integers in two's complement representation.

The control part 300 controls a selection process performed by the selection part 200 of the signed integer modular multiplication apparatus 10, and entirely controls the signed integer modular multiplication apparatus 10.

Next, a description will be made regarding an operation of the signed integer modular multiplication apparatus 10 according to the first example embodiment of the present invention with reference to FIG. 2 of an example embodiment of the present invention. The process of the signed integer modular multiplication apparatus 10 according to the first example embodiment of the present invention starts at step S100.

In step S101, the input part 100 receives an input 20 including a first signed integer A, a second signed integer B, a modular arithmetic divisor P, a positive integer n, and a constant R. The definitions of the first signed integer A, the second signed integer B, the modular arithmetic divisor P, the positive integer n, and the constant R are the same as those in one example embodiment of the present invention described with reference to FIGS. 1 and 2.

Next, in step S102, the second signed integer B 121 and the constant R 122 which are input to the selection part 200 are selected by the control part 300, and selected outputs 201 and 202 are sent to the multiplication part 210. The multiplication part 210 calculates the first product of 2n bits in length

$$BR {mod}^{\pm } {2}^{2 n}$$

from the second signed integer B and the constant R. The calculated first product is output to the output 211 of the multiplication part 210, stored by the first storage part 230, and is further output.

Next, in step S103, the first signed integer A 123 and the output 231 of the first storage part which are input to the selection part 200 are selected by the control part 300, and selected outputs 201 and 202 are sent to the multiplication part 210. Since the first product of 2n bits in length is output from the output 231 of the first storage part, the multiplication part 210 calculates the second product of 2n bits in length

$$Q = ABR {mod}^{\pm } {2}^{2 n}$$

from the first signed integer A and the first product. The calculated second product is output to an output 211 of the multiplication part 210, stored by the first storage part 230, and is further output.

Next, in step S104, the output 231 of the first storage part and the positive integer n 125 are input to the upper bit acquisition part 220. The output 231 of the first storage part is a second product of 2n bits in length, and the upper bit acquisition part 220 performs a signed n-bit right shift on the second product of 2n bits in length, performs integer approximation on the result to acquire the first upper bits

$$〚 \frac{Q}{{2}^{n}} 〛 ,$$

and outputs it as an output 221. The second storage part 240 stores the first upper bits and further outputs it as an output 241.

Next, in step S105, the modular arithmetic divisor P 124 and the output 241 of the second storage part which are input to the selection part 200 are selected by the control part 300, and the selected outputs 201 and 202 are sent to the multiplication part 210. Since the first upper bits are output from the output 241 of the second storage part, the multiplication part 210 calculates the third product of 2n bits in length

$$〚 Q / {2}^{n} 〛 P$$

from the first upper bits and the modular arithmetic divisor P. The calculated third product is output to an output 211 of the multiplication part 210. The first storage part 230 stores the third product and outputs it as the output 231.

Finally, in step S106, the output 231 of the first storage part and the positive integer n 125 are input to the upper bit acquisition part 220. The output 231 of the first storage part is the third product of 2n bits in length, and the upper bit acquisition part 220 performs a signed n-bit right shift on the third product of 2n bits in length, performs integer approximation on the result to acquire the second upper bits

$$〚 \frac{〚 \frac{Q}{{2}^{n}} 〛 P}{{2}^{n}} 〛 ,$$

and outputs it as the output 221. The second upper bits are stored by the second storage part 240 and output as the output 30. The process ends in step S107.

An example of a calculation of a remainder of a product of signed integers by a signed integer modular multiplication apparatus 10 according to the first example embodiment of the present invention is similar to an example of a modular calculation performed by the signed integer modular multiplication apparatus 10 according to one embodiment of the present invention described with reference to FIGS. 1 and 2.

### [Configuration of the Upper Bit Acquisition Part]

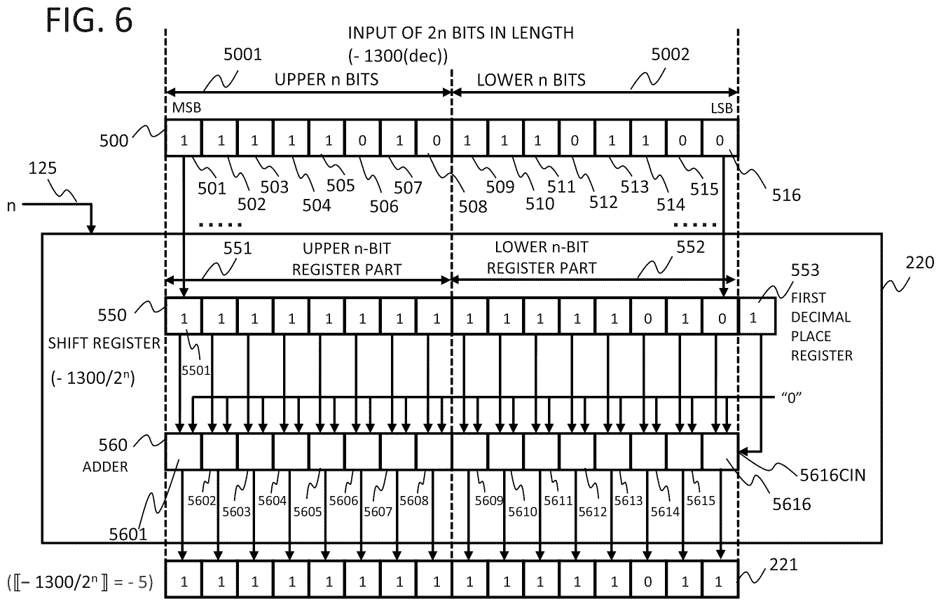

Next, a description will be made regarding a configuration and an operation of the upper bit acquisition part 220 with reference to FIG. 6. FIG. 6 is a diagram showing an example of the configuration of an upper bit acquisition part 220 of the signed integer modular multiplication apparatus 10 according to the first example embodiment of the present invention.

Referring to FIG. 6, the upper bit acquisition part 220 includes a shift register 550 and an adder 560. The upper bit acquisition part 220 receives an input 500 of 2n bits in length and an integer n125 as inputs.

Referring to FIG. 6, an input 500 of 2n-bit (16-bit) in length includes a most significant bit MSB (Most Significant Bit) 501 on the left, bits 502 to 515, and a least significant bit LSB (Least Significant Bit) 516 on the right. The input 500 is made up of upper n bits 5001 from bits 501 to 508 and lower n bits 5002 from bits 509 to 516.

In one example embodiment of the present invention, in an example of calculating a remainder of a product of signed integers, an example is shown in which −1300 (dec, decimal notation) in two's complement representation is input as an input to the upper bit acquisition part 220. Note that this value corresponds to the value of the second product input to the upper bit acquisition part 220 in the example of calculating a remainder of a product of signed integers in one example embodiment of the present invention. A description will be made below regarding a calculation operation of the upper bit acquisition part 220 when −1300 (dec, decimal notation) in two's complement representation is input.

The shift register 550 includes an upper n (8)-bit register part 551 and a lower n (8)-bit register part 552 for the input 500 of 2n bits (16 bits) in length, and a first decimal place register 553. The upper n (8) bits 5001 and the lower n (8) bits 5002 of the 2n bits (16 bits) in length input 500 are respectively loaded into each of the upper n (8)-bit register part 551 and the lower n (8)-bit register part 552 of the shift register 550.

Next, a signed n-bit right shift is performed on the input 500 of 2n bits (16 bits) in length loaded into the shift register 550 in accordance with the input integer n 125. The signed n-bit right shift is a process of shifting the input 500 loaded into the shift register 550 by n bits in the direction from the MSB to the LSB. At this time, a value of the MSB indicating the sign of the bit 501 is set in the upper n (8)-bit register part 551 of the shift register 550.

Referring to FIG. 6, the values shown in each register of the shift register 550 indicate a result of loading the input 500 into the shift register 550 and performing a signed n (8) bit right shift. The value of the MSB 501 is set in the upper n (8)-bit register part 551 of the shift register 550, and the lower n (8)-bit register part 552 of the shift register 550 has the upper n bits 5001 of the input 500 placed therein, and the value of bit 509 of the input 500 is set in the first decimal place register 553 of the shift register 550.

Next, integer approximation is performed on the output of the shift register 550 after the signed n-bit right shift. The integer approximation is performed, for example, by rounding a first decimal place. The rounding a first decimal place is performed, for example, by the adder 560.

Referring to FIG. 6, an adder 560 includes 2n (16) full adders 5601 to 5616, each having two inputs, a carry input, and a carry output, with the carry output of a lower full adder (e.g., full adder 5603) connected to the carry input of the next higher full adder (e.g., full adder 5602).

The output of the upper n-bit register part 551 of the shift register 550 is input to one input of each of the full adders 5601 to 5608 of the adder 560, and the output of the lower n-bit register part 552 of the shift register 550 is input to one input of each of the full adders 5609 to 5616. A value of 0 (zero) is input to all the other inputs of each of the full adders 5601 to 5616 of the adder 560. In addition, the output of the first decimal place register 553 is input to the carry input 5616CIN of the full adder 5616.

Referring to FIG. 6, −5 in two's complement representation is output from the output 221 of the adder 560, and

$$〚 - 1300 / {2}^{n} 〛 = - 5$$

is acquired by the upper bit acquisition part 220 of the signed integer modular multiplication apparatus 10 of the first example embodiment of the present invention. Note that, this value corresponds to the value of the first upper bits, −5, in the example of the calculation of a remainder of a product of signed integers of one example embodiment of the present invention.

Note, the upper bit acquisition part 220 of the signed integer modular multiplication apparatus 10 of one example embodiment of the present invention and another example embodiment described with reference to FIGS. 1 and 3 may have the similar configuration to the upper bit acquisition part 220 of the signed integer modular multiplication apparatus 10 of the first example embodiment of the present invention.

As described above, the signed integer modular multiplication apparatus 10 of the first example embodiment of the present invention can calculate the remainder of the product of the signed integers

$$AB ( - {2}^{- 2 n} ) {mod}^{\pm } P .$$

According to the first example embodiment of the present invention, there are provided a signed integer modular multiplication apparatus, a signed integer modular multiplication method contribute to making it possible to calculate a remainder of a product on data represented by signed integers without converting negative data into data represented by an unsigned integer.

### Second Example Embodiment

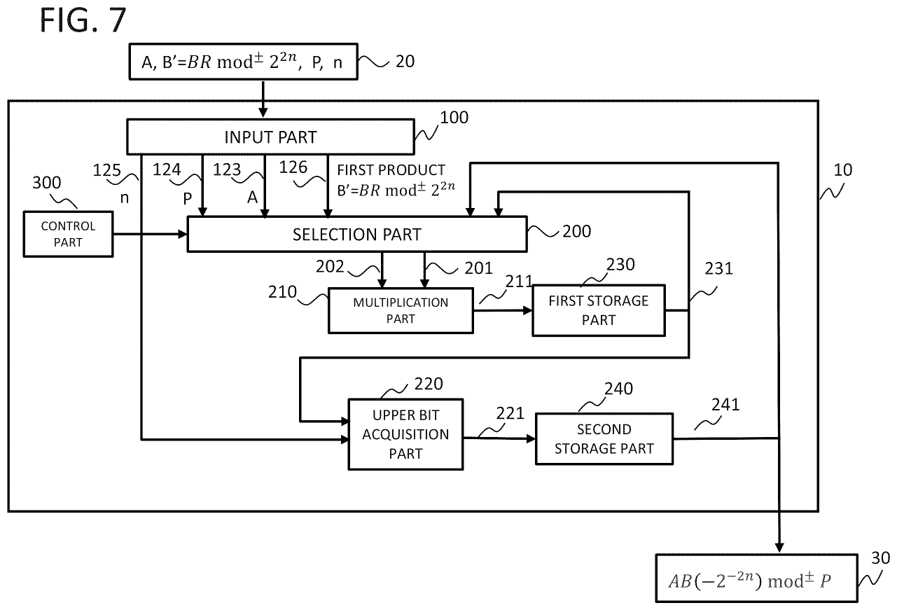

Next, a description will be made regarding a signed integer modular multiplication apparatus (calculation apparatus of a remainder of a product of signed integers) according to a second example embodiment of the present invention with reference to the drawings. FIG. 7 is a diagram showing an example of a configuration of a signed integer modular multiplication apparatus according to the second example embodiment of the present invention. In FIG. 7, it is assumed that the components with the same reference signs as those in FIG. 5 are the same.

Depending on the application of a modular multiplication, the pre-calculation of the first product described in the first example embodiment of the present invention

$${B}^{′} = BR {mod}^{\pm } {2}^{2 n}$$

may be performed, and the second example embodiment of the present invention is in case where the first product is calculated in advance.

Next, a description will be made with reference to FIG. 4 of another example embodiment of the present invention regarding the operation of the signed integer modular multiplication apparatus 10 according to the second example embodiment of the present invention. The process of the signed integer modular multiplication apparatus 10 according to the second example embodiment of the present invention starts at step S200.

In step S201, the input part 100 receives an input 20 including a first signed integer A, a first product of 2n bits in length

$${B}^{′} = BR {mod}^{\pm } {2}^{2 n} ,$$

a modular arithmetic divisor P, and a positive integer n, without receiving a second signed integer B and a constant R. The definitions of the first signed integer A, the second signed integer B, the modular arithmetic divisor P, the positive integer n, and the constant R are the same as those described in the one example embodiment of the present invention described with reference to FIGS. 1 and 2.

Next, in step S202, the first signed integer A 123 and the first product 126 of 2n bits in length input to the selection part 200 are selected by the control part 300 and the selected outputs 201 and 202 are sent to the multiplication part 210. The multiplication part 210 calculates a second product of 2n bits in length Q=ABR mod^{±}2²ⁿ from the first signed integer A and the first product. The calculated second product is output to the output 211 of the multiplication part 210, stored by the first storage part 230, and further output.

Next, in step S203, the output 231 of the first storage part and the positive integer n 125 are input to the upper bit acquisition part 220. The output 231 of the first storage part is a second product of 2n bits in length, and the upper bit acquisition part 220 performs a signed n-bit right shift on the second product of 2n bits in length, and performs integer approximation on the result to acquire the first upper bits

$$〚 Q / {2}^{n} 〛$$

that is output as the output 221. The second storage part 240 stores the first upper bits and outputs it as the output 241.

Next, in step S204, the modular arithmetic divisor P 124 and the output 241 of the second storage part input to the selection part 200 are selected by the control part 300, and sent the selected outputs 201 and 202 to the multiplication part 210. Since the first upper bits are output to the output 241 of the first storage part, the multiplication part 210 calculates the third product of 2n bits in length

$$〚 Q / {2}^{n} 〛 P$$

from the first upper bits and the modular arithmetic divisor P. The calculated third product is output to the output 211 of the multiplication part 210. The first storage part 230 stores the third product and further outputs it as the output 231.

Finally, in step S205, the output 231 of the first storage part and the positive integer n 125 are input to the upper bit acquisition part 220. The output 231 of the first storage part is the third product of 2n bits in length, and the upper bit acquisition part 220 performs a signed n-bit right shift on the third product of 2n bits in length, performs integer approximation on the result to acquire the second upper bits

$$〚 \frac{〚 \frac{Q}{{2}^{n}} 〛 P}{{2}^{n}} 〛 ,$$

and outputs it as the output 221. The second upper bits are stored by the second storage part 240 and is further output as the output 30. The process ends in step S206.

An example of the calculation of a remainder of a product of signed integers by the signed integer modular multiplication apparatus 10 according to the second example embodiment of the present invention is similar to the example of a calculation of a remainder of a product performed by the signed integer modular multiplication apparatus 10 according to one example embodiment of the present invention described with reference to FIGS. 1 and 2.

Note, the operation of the upper bit acquisition part 220 of the signed integer modular multiplication apparatus 10 of the second example embodiment of the present invention may be similar to the configuration and the operation of the first upper bit acquisition part 220 of the signed integer modular multiplication apparatus 10 of the first example embodiment of the present invention described with reference to FIG. 6.

As described above, the signed integer modular multiplication apparatus 10 of the first example embodiment of the present invention can calculate the remainder of the product of the signed integers

$$AB ( - {2}^{- 2 n} ) {mod}^{\pm } P .$$

According to the second example embodiment of the present invention, there are provided a signed integer modular multiplication apparatus, a signed integer modular multiplication method, and a program that contribute to making it possible to calculate a remainder of a product on data represented by signed integers without converting negative data into data represented by an unsigned integer.

Further, according to the second example embodiment of the present invention, in an application example in which the first product can be pre-calculated, step S102 of calculating the first product in the first example embodiment of the present invention described with reference to FIG. 2 can be omitted, and the calculation of the remainder of the product can be speeded up.

### Third Example Embodiment

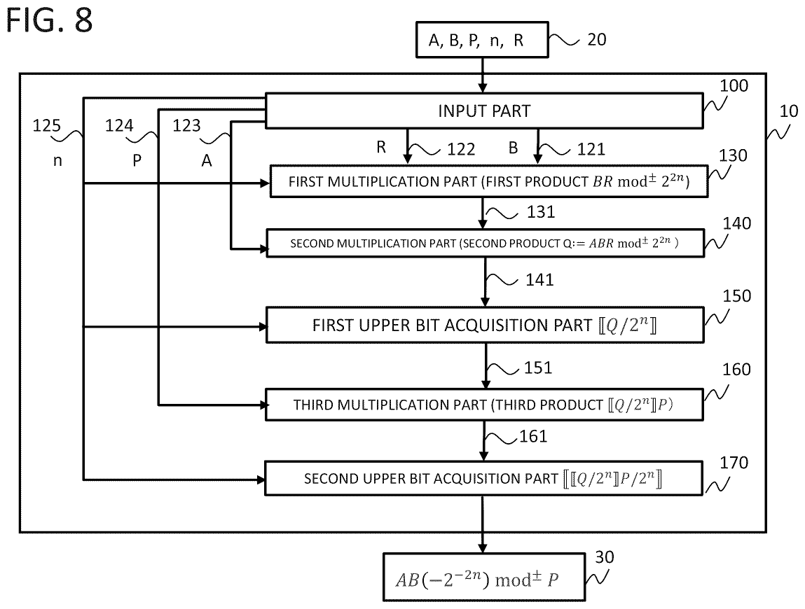

Next, a description will be made with reference to the drawings regarding a signed integer modular multiplication apparatus (calculation apparatus of a remainder of a product of signed integers) according to a third example embodiment of the present invention. FIG. 8 is a diagram showing an example of a configuration of a signed integer modular multiplication apparatus according to a third example embodiment of the present invention. In FIG. 8, it is assumed that components with the same reference signs as those in FIG. 5 are the same.

The signed integer modular multiplication apparatus 10 of the third example embodiment of the present invention shown in FIG. 8 includes an input part 100, a first multiplication part 130, a second multiplication part 140, a first upper bit acquisition part 150, a third multiplication part 160, and second upper bit acquisition part 170 each executes each step of the flowchart showing an example of processing by the signed integer modular multiplication apparatus of one example embodiment of the present invention shown in FIG. 2.

The input part 100 executes the process of step S101 in FIG. 2 and receives an input 20 including a first signed integer A, a second signed integer B, a modular arithmetic divisor P, a positive integer n, and a constant R.

The first multiplication part 130 executes the process of step S102 in FIG. 2, and calculates a first product 131 of 2n bits in length from the second signed integer B121 and the constant R122.

The second multiplication part 140 executes the process of step S103 in FIG. 2, and calculates a second product 141 of 2n bits in length from the first product 131 and the first signed integer A 123.

The first upper bit acquisition part 150 executes the process of step S104 in FIG. 2, and acquires the first upper bits 151 by performing integer approximation on the result of the signed n-bit right shift of the second product 141.

The third multiplication part 160 executes the process of step S105 in FIG. 2, and calculates a third product 161 of 2n bits in length from the first upper bits 151 and the modular arithmetic divisor P 124.

The second upper bit acquisition part 170 executes the processing of step S106 in FIG. 2, and performs integer approximation on the result of the signed n-bit right shift on the third product 161 to acquire the second upper bits to output them as output 30.

### Fourth Example Embodiment

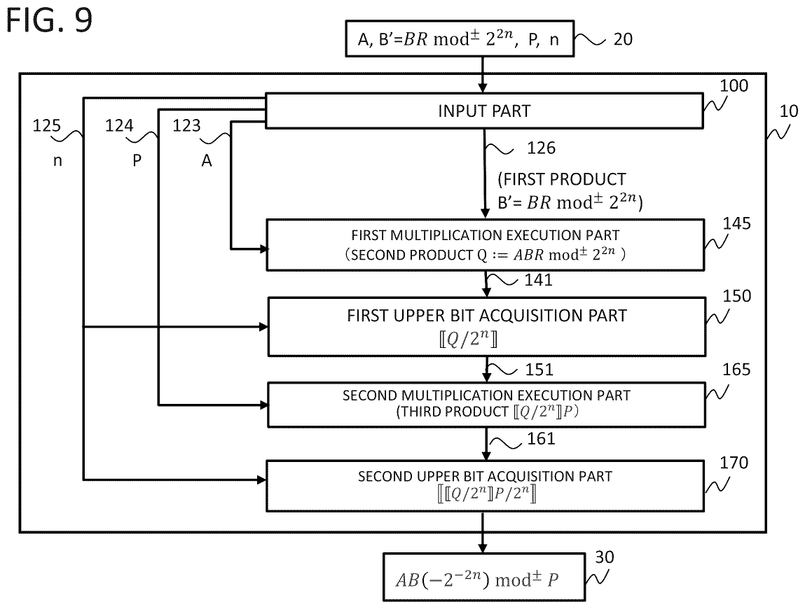

Next, a description will be made with reference to the drawings regarding a signed integer modular multiplication apparatus (calculation apparatus of a remainder of a product of signed integers) according to a fourth example embodiment of the present invention. FIG. 9 is a diagram showing an example of a configuration of a signed integer modular multiplication apparatus according to the fourth example embodiment of the present invention. In FIG. 9, it is assumed that the components with the same reference signs as those in FIG. 7 are the same.

The signed integer modular multiplication apparatus 10 of the fourth example embodiment of the present invention described in FIG. 9 includes an input part 100, a first multiplication execution part 145, a first upper bit acquisition part 150, a second multiplication execution part 165, and a second upper bit acquisition part 170 each executes each of steps in the flowchart showing an example of processing by the signed integer modular multiplication apparatus of another example embodiment of the present invention shown in FIG. 4.

The input part 100 executes the process of step S201 in FIG. 4 and receives an input 20 including a first signed integer A, a first product

$${B}^{′} = BR {mod}^{\pm } {2}^{2 n} ,$$

a modular arithmetic divisor P, and a positive integer n.

The first multiplication execution part 145 executes the process of step S202 in FIG. 4, and calculates a second product 141 of 2n bits in length from the first product 126 and the first signed integer A 123.

The first upper bit acquisition part 150 executes the process of step S203 in FIG. 4, and acquires the first upper bits 151 by performing integer approximation on the result of the signed n-bit right shift of the second product 141.

The second multiplication execution part 165 executes the process of step S204 in FIG. 4, and calculates a third product 161 of 2n bits in length from the first upper bits 151 and the modular arithmetic divisor P 124.

The second upper bit acquisition part 170 executes the processing of step S205 in FIG. 4, and performs integer approximation on the result of the signed n-bit right shift on the third product 161 to acquire the second upper bits to output them as output 30.

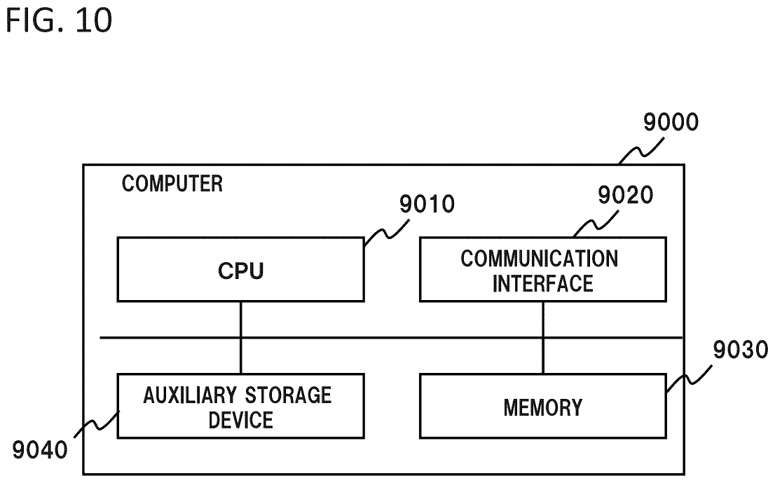

Moreover, the procedures shown in the above-mentioned one, another and first to fourth example embodiments can be implemented by a program that causes a computer (9000 in FIG. 10) functioning as the signed integer modular multiplication apparatus 10 to realize the function as the signed integer modular multiplication apparatus 10. Such a computer is exemplified by a configuration including a CPU (Central Processing Unit) 9010, a communication interface 9020, a memory 9030, and an auxiliary storage device 9040 in FIG. 10. That is, the CPU 9010, in FIG. 10, executes a program for the calculation of a remainder of a product of signed integers, and performs an update process for each calculation parameter stored in the auxiliary storage device 9040, etc.

The memory 9030 is a RAM (Random Access Memory), a ROM (Read Only Memory), etc.

That is, each part (processing means, function) of the signed integer modular multiplication apparatus 10 shown in the above-mentioned one, another and first to fourth example embodiments can be realized by a computer program that causes the processor of the above-mentioned computer to execute each of the above-mentioned processes using its hardware.

Finally, preferred modes of the present invention will be summarized.

### [Mode 1]

### (Refer to the Signed Integer Modular Multiplication Apparatus According to the First Aspect Above.)

### [Mode 2]

### (Refer to the Signed Integer Modular Multiplication Apparatus According to the Second Aspect Above.)

### [Mode 3]

In the signed integer modular multiplication apparatus according to mode 1 or 2, it is preferable that the constant R is an integer that satisfies R=P⁻¹ mod^{±}2²ⁿ for the modular arithmetic divisor P and the positive integer n, and mod^{±}2²ⁿ indicates the modular calculation of a signed integer modulo 2²ⁿ.

### [Mode 4]

In the signed integer modular multiplication apparatus according to mode 3, it is preferable that the integer approximation is performed by rounding a first decimal place.

### [Mode 5]

### (Refer to the Signed Integer Modular Multiplication Method According to the Third Aspect Above.)

### [Mode 6]

### (Refer to the Signed Integer Modular Multiplication Method According to the Fourth Aspect Above.)

### [Mode 7]

### (Refer to the Program According to the Fifth Aspect Above.)

### [Mode 8]

### (Refer to the Program According to the Sixth Aspect Above.)

### [Mode 9]

In the program according to mode 7 or 8, it is preferable that the constant R is an integer that satisfies R=P⁻¹ mod^{±}2²ⁿ for the modular arithmetic divisor P and the positive integer n, and mod^{±}2²ⁿ indicates the modular calculation of a signed integer modulo 2²ⁿ.

### [Mode 10]

In the program according to mode 9, it is preferable that the integer approximation is performed by rounding a first decimal place.
The above modes 5 or 6 can be expanded to modes 3 and 4.

The disclosure of each of the above Patent Literatures a is incorporated herein by reference thereto. Variations and adjustments of the example embodiments and examples are possible within the scope of the overall disclosure (including the claims) of the present invention and based on the basic technical concept of the present invention. Various combinations and selections of various disclosed elements (including the elements in each of the claims, example embodiments, examples, drawings, etc.) are possible within the scope of the disclosure of the present invention. Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not particularly mentioned.

### REFERENCE SIGNS LIST

10 Signed Integer Modular Multiplication Apparatus
20 Input
30 Output
100 Input Part
121 Second Signed Integer B
122 Constant R
123 First Signed Integer A
124 Modular Arithmetic Divisor P
125 Integer n
130 First Multiplication Part
140 Second Multiplication Part
145 First Multiplication Execution Part
150 First Upper Bit Acquisition Part
160 Third Multiplication Part
165 Second Multiplication Execution Part
170 Second Upper Bit Acquisition Part
200 Selection Part
210 Multiplication Part
220 Upper Bit Acquisition Part
230 First Memory Part
240 Second Memory Part
300 Control Part
550 Shift Register
551 Upper n (8)-Bit Register Part
552 Lower n (8)-Bis Register Part
553 First Decimal Place Register
560 Adder
5001 Upper n (8) Bits
5002 Lower n (8) Bits
5601-5616 Full Adder
9000 Computer
9010 CPU
9020 Communication Interface
9030 Memory
9040 Auxiliary Storage Device

What is claimed is:

1. A signed integer modular multiplication apparatus, comprising:
at least a processor; and
a memory in circuit communication with the processor,
wherein the processor is configured to execute program instructions stored in the memory to perform:
receiving a first signed integer, a second signed integer, a modular arithmetic divisor P, a positive integer n, and a constant R;
multiplying; and
acquiring upper bits, wherein
the multiplying includes calculating a first product of 2n bits in length from the second signed integer and the constant R,
the multiplying includes calculating a second product of 2n bits in length from the first product and the first signed integer,
the acquiring upper bits includes performing integer approximation on a result of a signed n-bit right shift on the second product to acquire first upper bits,
the multiplying includes calculating a third product of 2n bits in length from the first upper bits and the modular arithmetic divisor P, and
the acquiring upper bits includes performing integer approximation on the result of a signed n-bit right shift on the third product to acquire second upper bits, and wherein
the constant R is a reciprocal of the modular arithmetic divisor P by a calculation of a signed integer modulo2²ⁿ.

2. A signed integer modular multiplication apparatus, comprising:
at least a processor; and
a memory in circuit communication with the processor,
wherein the processor is configured to execute program instructions stored in the memory to perform:
receiving a first signed integer, a first product of 2n bits in length calculated in advance from a second signed integer and a constant R, a modular arithmetic divisor P, a positive integer n;
multiplying; and
acquiring upper bits, wherein
the multiplying includes calculating a second product of 2n bits in length from the first product and the first signed integer,
the acquiring upper bits includes performing integer approximation on a result of a signed n-bit right shift on the second product to acquire first upper bits,
the multiplying includes calculating a third product of 2n bits in length from the first upper bits and the modular arithmetic divisor P, and
acquiring upper bits includes performing integer approximation on the result of a signed n-bit right shift on the third product to acquire second upper bits, and wherein
the constant R is a reciprocal of the modular arithmetic divisor P by a calculation of a signed integer modulo 2²ⁿ.

3. The signed integer modular multiplication apparatus according to claim 1, wherein the constant R is an integer that satisfies R=P⁻¹mod^{±}2²ⁿ for the modular arithmetic divisor P and the positive integer n, and mod^{±}2²ⁿ indicates the modular calculation of a signed integer modulo 2²ⁿ.

4. The signed integer modular multiplication apparatus according to claim 3, wherein the integer approximation is performed by rounding a first decimal place.

5. A signed integer modular multiplication method comprising:
receiving a first signed integer, a second signed integer, a modular arithmetic divisor P, a positive integer n, and a constant R with an input part;
calculating a first product of 2n bits in length from the second signed integer and the constant R with a multiplication part;
calculating a second product of 2n bits in length from the first product and the first signed integer with the multiplication part;
performing integer approximation on a result of a signed n-bit right shift on the second product to acquire first upper bits with an upper bit acquisition part;
calculating a third product of 2n bits in length from the first upper bits and the modular arithmetic divisor P with the multiplication part; and
performing integer approximation on the result of a signed n-bit right shift on the third product to acquire second upper bits with the upper bit acquisition part, and wherein
the constant R is a reciprocal of the modular arithmetic divisor P by a modular calculation of a signed integer modulo 2²ⁿ.

6. A signed integer modular multiplication method, comprising:
receiving a first signed integer, a first product of 2n bits in length calculated in advance from a second signed integer and a constant R, a modular arithmetic divisor P, and a positive integer n with an input part;
calculating a second product of 2n bits in length from the first product and the first signed integer with a multiplication part;
performing integer approximation on a result of a signed n-bit right shift on the second product to acquire first upper bits with an upper bit acquisition part;
calculating a third product of 2n bits in length from the first upper bits and the modular arithmetic divisor P with the multiplication part; and
performing integer approximation on the result of a signed n-bit right shift on the third product to acquire second upper bits with the upper bit acquisition part, and wherein
the constant R is a reciprocal of the modular arithmetic divisor P by a modular calculation of a signed integer modulo 2²ⁿ.

7-10. (canceled)

11. The signed integer modular multiplication apparatus according to claim 2, wherein the constant R is an integer that satisfies R=P⁻¹ mod^{±}2²ⁿ for the modular arithmetic divisor P and the positive integer n, and mod^{±}2²ⁿ indicates the modular calculation of a signed integer modulo 2²ⁿ.

12. The signed integer modular multiplication apparatus according to claim 11, wherein the integer approximation is performed by rounding a first decimal place.

13. The signed integer modular multiplication method according to claim 5, wherein the constant R is an integer that satisfies R=P⁻¹ mod^{±}2²ⁿ for the modular arithmetic divisor P and the positive integer n, and mod^{±}2²ⁿ indicates the modular calculation of a signed integer modulo 2²ⁿ.

14. The signed integer modular multiplication method according to claim 13, wherein the integer approximation is performed by rounding a first decimal place.

15. The signed integer modular multiplication method according to claim 6, wherein the constant R is an integer that satisfies R=P⁻¹ mod^{±}2²ⁿ for the modular arithmetic divisor P and the positive integer n, and mod⁺2²ⁿ indicates the modular calculation of a signed integer modulo 2²ⁿ.

16. The signed integer modular multiplication method according to claim 15, wherein the integer approximation is performed by rounding a first decimal place.
